(19) United States
(12) Patent Application Publication
(10) Pub. No.: US 2023/0011788 A1
(43) Pub. Date: Jan. 12, 2023

(54) A SYSTEM FOR DIGITAL ASSET EXCHANGE, A DIGITAL WALLET AND AN ARCHITECTURE FOR EXCHANGING DIGITAL ASSETS

(71) Applicant: Ix Asia Limited, Pok Fu Lam (HK)

(72) Inventors: Oi Ling Irene Wong, West Point (HK); Chun Ho Lee, Pok Fu Lam (HK)

(21) Appl. No.: 17/781,941

(22) PCT Filed: Jul. 27, 2021
(86) PCT No.: PCT/CN2021/108714

§ 371 Date: Jun. 2, 2022

(30) Foreign Application Priority Data
Oct. 15, 2020 (HK) 32020018131.3

(51) Int. Cl. G06Q 40/04; G06Q 20/02; G06Q 20/36; G06Q 20/40; G06Q 20/38; G06Q 20/20

(52) U.S. Cl. CPC G06Q 40/04; G06Q 20/027; G06Q 20/3674; G06Q 20/40145; G06Q 20/3829; G06Q 20/20; G06Q 2220/00

(57) ABSTRACT

A system for digital asset exchange, a digital wallet and an architecture for exchanging digital assets. The system for digital asset exchange includes an interface arranged to receive digital asset transaction requests from a user; and a gateway arranged to communicate with one or more exchanges to process the digital asset transaction requests.

### TECHNICAL FIELD

The present invention relates to a system for digital asset exchange, a digital wallet and an architecture for exchanging digital assets, and particularly, although not exclusively, to a system, wallet and architecture incorporating thereof arranged for the exchange of digital assets.

### BACKGROUND

Digital assets such as cryptocurrencies have been popular in recent times. Investors, including those who have little experience, have shown an interest in investing in cryptocurrencies or to use them for their everyday consumption. Companies have also explored the options of using cryptocurrencies to raise funds and build interests in their business with initial coin offerings (ICOs).

Despite these interests, there have been a slow adoption of cryptocurrencies in transactions by regular consumers. Cryptocurrencies have a misunderstood reputation within the existing legal and regulatory framework and thus have created much confusion and resistance from regular consumers. Furthermore, the infrastructure behind the trading of cryptocurrencies are often difficult to use or lack substantive transparency expected by general investors. In turn, the trading of cryptocurrencies are difficult for the ordinary investor as information regarding cryptocurrencies are difficult to track when compared with ordinary securities.

### SUMMARY OF THE INVENTION

In accordance with a first aspect of the present invention, there is provided a system for digital asset exchange comprising: an interface arranged to receive digital asset transaction requests from a user, and a gateway arranged to communicate with one or more exchanges to process the digital asset transaction requests.

In an embodiment of the first aspect, the digital asset transaction request includes an exchange of digital assets with regular currencies.

In an embodiment of the first aspect, the interface is further arranged to receive at least one digital asset index.

In an embodiment of the first aspect, the system further includes a point service arranged to perform transactions with points.

In an embodiment of the first aspect, the points have a predetermined value associated with a selected regular currency.

In an embodiment of the first aspect, the point service exchanges points for digital assets or regular currencies.

In an embodiment of the first aspect, the point service is further arranged to facilitate, between multiple users, payment or transaction of the points having the predetermined value associated with different regular currencies.

In an embodiment of the first aspect, the point service is further arranged to facilitate cross-border payment or transaction.

In an embodiment of the first aspect, the digital asset exchange is arranged to receive regular currencies.

In an embodiment of the first aspect, a digital wallet is generated for a user upon a digital asset exchange transaction if performed.

In an embodiment of the first aspect, the digital wallet includes a wallet identification code.

Preferably, the wallet identification code includes a key, which is unique to each wallet and may include a private key paired to a public key which are used selectively by the wallet when transactions are performed.

In an embodiment of the first aspect, the wallet identification code is presented in paper form.

In an embodiment of the first aspect, the system further includes an authentication module arranged to authenticate the user.

In an embodiment of the first aspect, the authentication module is further arranged to verify the user based on at least one of biometric information authentication and identity document authentication.

In an embodiment of the first aspect, the authentication module comprises at least one of a face-recognition camera, a fingerprint scanner, and an optical imager arranged to scan an identity document of the user.

In an embodiment of the first aspect, the system is further arranged to interact with a user digital wallet service to facilitate the transaction of the digital asset transaction requests.

In an embodiment of the first aspect, the user digital wallet service is compliance checked before the digital asset transaction requests are processed.

In an embodiment of the first aspect, the compliance check includes a review of the history of past transactions of the digital wallet service.

In an embodiment of the first aspect, the user digital wallet service is a distributed ledger wallet.

In an embodiment of the first aspect, the gateway further arranged to, upon processing the digital asset transaction requests, deposit a digital asset holding owned by the user in a custodian arranged to manage the deposited digital asset holding.

In an embodiment of the first aspect, the deposited digital asset holding has a market value associated with the predetermined value of the points allocated to the user upon processing the digital asset transaction requests.

In an embodiment of the first aspect, the point service is arranged to perform transactions with points without intervening the deposited digital asset holding managed by the custodian.

In an embodiment of the first aspect, the digital asset index is updated approximately every 15 seconds.

In an embodiment of the first aspect, the digital asset index is updated based on a weighted average of a report price for each of a plurality of constituent.

In an embodiment of the first aspect, the digital asset index is further associated with an index divisor adjusted based on an update of constituents after a predetermined cut-off date.

In accordance with a second aspect of the present invention, there is provided a digital application for digital asset exchange comprising:
a distributed ledger wallet have at least a private key and public key for recording the transaction of digital assets
a gateway to communicate with one or more exchanges to process the digital asset transaction requests;

In an embodiment of the second aspect, the digital applications includes an interface arranged to present at least one digital asset index.

In an embodiment of the second aspect, the digital application is arranged to operate with a system for digital asset exchange in accordance with any one of the embodiments of the first aspect of the invention.

In accordance with a third aspect of the present invention, there is provided an architecture for exchanging digital assets comprising: at least one system for digital asset exchange in accordance with any one of the embodiments of the first aspect of the present invention; a point exchange module arranged to perform the exchange of points with digital assets or regular currencies; at least one exchange arranged to perform digital asset transactions; and a digital application in accordance with any one of the second aspect of the present invention.

In an embodiment of the third aspect, the point exchange module is further arrange to facilitate digital payment at a physical point of sales associated with the points.

In an embodiment of the third aspect, the point exchange module includes a digital payment instrument.

### BRIEF DESCRIPTION OF THE DRAWINGS

Embodiments of the present invention will now be described, by way of example, with reference to the accompanying drawings in which:

FIG. 1 is a block diagram of an example architecture for exchanging digital assets;

FIG. 2A is a drawing of an example digital asset exchange machine (DAEM);

FIG. 2B is a flow diagram of the DAEM of FIG. 3A in operation;

FIG. 3 is a screenshot of an example digital wallet;

FIG. 4 is a block diagram illustrating the communication of an example digital asset index;

FIG. 5 is a block diagram illustrating a transaction between two users using the example architecture of FIG. 1;

FIGS. 6A and 6B are illustrations showing example operations of the digital asset holding in the public domain and the token/points managed in the private domain in accordance with embodiments of the present invention.

### DETAILED DESCRIPTION OF THE PREFERRED EMBODIMENT

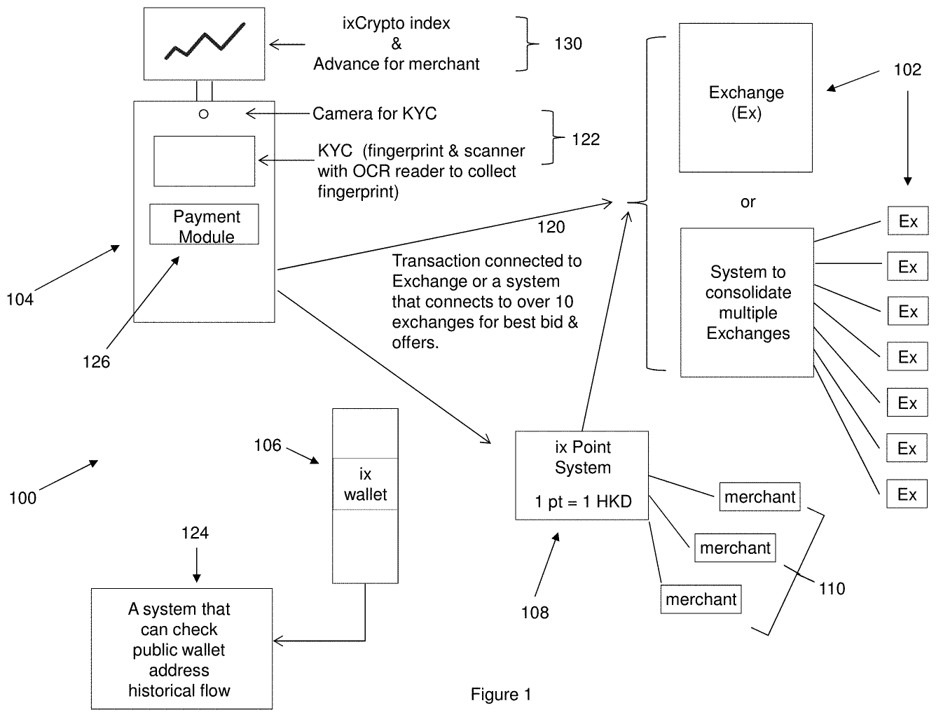

Referring to FIG. 1, there is presented a block diagram illustrating an example architecture for exchanging digital assets. In this embodiment, the architecture includes a number of components, including one or more systems for exchanging digital assets 104, one or more digital wallets or digital wallet services 106, one or more exchanges 102, which are specialist digital asset exchanges that are approved to operate for the trading of digital assets such as cryptocurrencies or other forms of crypto-assets with other cryptocurrencies or regular currencies (Fiat currencies), commodities, securities, assets or derivatives. The term “regular currencies” used herein will include (Fiat currencies), commodities, securities, assets or derivatives.

As shown, the exchanges 102 are arranged to communicate with at least one digital asset exchange systems 104 which are arranged to allow digital asset transaction requests to be made by users, and preferably, after validation, the digital asset exchange systems 104 may communicate with the exchange 102 to execute the transaction.

In this example, the digital asset exchange architecture 100 includes at least one system for digital asset exchange 104, which may also be referred to as a digital asset exchange system 104 or as a digital asset exchange machine (DAEM) 104. The DAEM 104 may be used by a user to exchange digital assets or to perform any digital assets transactions. Such transactions may include the purchase or sale of digital assets with regular currency (e.g. fiat currency) with cash or with other forms of credit or debit facilitate or other assets or derivatives. The DAEM 104 may also be arranged to perform additional transactions which may not necessarily require an exchange 102, such as the transfer of digital assets between multiple digital wallets belonging to different users or merchants.

In this example embodiment, the user may interact with the DAEM 104 by placing a transaction order 120 with the DAEM 104. The transaction order 120 may then be validated by several implemented security systems, including biometric scanning or other forms of authentication systems to authenticate the identity of the user 122. Once the user has been authenticated, their transaction 120 request can then be received for process.

For example, the authentication module is further arranged to verify the user based on biometric information authentication, such as by using a face-recognition camera or a fingerprint scanner to verify the user, and/or based on identity document authentication such as using an optical imager or a scanner to scan an identity document (e.g. identity card, passport) of the user. The authentication module may also read the text using OCR methods so as to extract the textual information of the scanned documents for other purposes, e.g. as image textual input for processing the digital asset transaction requests or for other purposes. Advantageous, the authentication module may facilitate compliance requirements according to know your client (KYC) guidelines and/or anti-money laundering (AML) policy in financial services.

Alternatively, the interaction with the KYC process may be performed on the user's device instead of on the DEAM 104. For example, all the necessary documents may be scanned and/or uploaded using the ixWallet application, and the user identify authentication based on biometric information authentication may be done via the authentication on ixWallet application and/or using the security modules in the user's device. In this embodiment, the authentication module may request the user to use his device to scan a dynamic QR code displayed on the DEAM, then followed by authentication on the client's device using the ixWallet application. Upon successful authentication using the ixWallet application, the authentication module is notified, and then the user may continue operating on the DEAM 104. Advantageously, this allow the user to more frequently and conveniently update or upload necessary documents for KYC purposes, and it is also more preferable to some users who may wish to only store sensitive information in trusted devices.

Depending on the transaction request 102, the user may need to provide their digital asset wallet details. The digital asset wallet may be a cryptocurrency wallet 106 which record the transactions of the digital asset for a specific unique account. This digital wallet may operate, in some examples, with a unique public and private key pair which is selectively shared when a transaction is required, with the digital wallet keeping a ledger of the transactions. Preferably, as in the case of certain cryptocurrencies, the ledger is distributed, thus meaning it is decentralized and stored on a distributed system such as a blockchain. Preferably, it is not necessary for the cryptocurrency wallet 106 or the ixWallet application to record or store any transaction of the cryptocurrency as all the completed transaction are recorded in the blockchain ledger, and the wallet 106 may simply display the recorded transaction in the blockchain upon request.

The wallet 106 may also be checked for security or compliance purposes by a module 124 arranged to, in some examples, check the history of the wallet's public keys or addresses to determine if the wallet has been involved in illegal or dubious transactions, and raise these warnings for review or termination of the transaction request 120 if necessary.

The transaction request 102 may then be cleared at one or more exchanges, with the DAEM 104 sending the transaction request to one or more exchanges 102 for clearance. Following specific clearance requirements of specific cryptocurrencies, once cleared, the user will be notified of the completion of the transaction 120 and their digital wallet 106 will be updated.

As shown in this architecture 100, the user may also be able to purchase cryptocurrencies with regular currencies or other assets with the DAEM 104. This may be performed by providing cash or by use of other credit or debit facilities (e.g. use of credit card or electronic payment systems). A conversion rate may be applied at the time and the transaction request 120 may be sent to the exchange for clearance so that the user may be able to purchase the cryptocurrency. In this example, the DAEM 104 may be implemented with a payment module 126 or device arranged to receive cash, credit card details or bank account details for payment. This payment module 126 may be arranged to receive all types of payment including cash, and thus may have a cash counting device. The payment module 126 may also have a credit/debit card reader, account scanner, keypad for account entry as well as NFC/RFID or contactless payment facilities.

In some examples, a new user may not have a digital wallet 106 as the idea of a digital wallet may be new to some new investor of digital assets or cryptocurrencies. In such examples, the DAEM 104 may be able to generate a new digital wallet 106 for the user on request. To provide the new digital wallet 106 to the user, the DAEM may print, or otherwise send, a code for the user which would be an identity of their new digital wallet 106. This new code may be used for any subsequent transaction with the cryptocurrency which has just been purchased. The DAEM 104 may print a copy of this code onto a slip of paper, thus providing what is referenced as a “paper wallet”. The purpose of this wallet 106 is such that a user can present the “paper wallet” at their next cryptocurrency transaction. This is particularly advantageous as users who are new to cryptocurrencies may be required to perform a specific one off transaction with their cryptocurrencies. Such users may have no need to maintain a digital wallet 106 for their cryptocurrency in the long term, but by being able to purchase the cryptocurrency in one basic transaction with regular currencies, the user is able to proceed with their subsequent transaction with their cryptocurrency for their required goods or services.

In another example embodiment, the DAEM may also undergo a specific account opening procedures for specific functions which require adherence to government or legal requirements. In these examples where a user wishes to use the DAEM for these specific services, the DAEM may be arranged to receive the identification details or other information as required from the new user before the DAEM can establish an account for a new user. This information may then be sent for validation at authorized or government operated exchanges such that the initial stages of account opening can be performed.

As shown in this example architecture, there is also provided a digital wallet or digital wallet service referred to as an ix wallet or ixWallet 106. In this example, the ixWallet 106 is a distributed ledger wallet and allows a user to maintain their digital assets holdings. The ixWallet 106 is arranged to work with one or more different digital assets and may be implemented with an interface to show different functions for the user, including an interactive function to allow users to perform transactions with their digital assets as well as to check their balances of different digital assets. Security technology, such as end-to-end email/file encryption and digital signing system that utilizes a proprietary API as the underlying cryptographic system to ensure safety against cyberattacks from conventional world of computers and also against attacks from quantum computers, may also be implemented to ensure the digital wallet remains secure. Such technology may be advantageous as the use of code base cryptography will remain secure despite developments of quantum computing technologies.

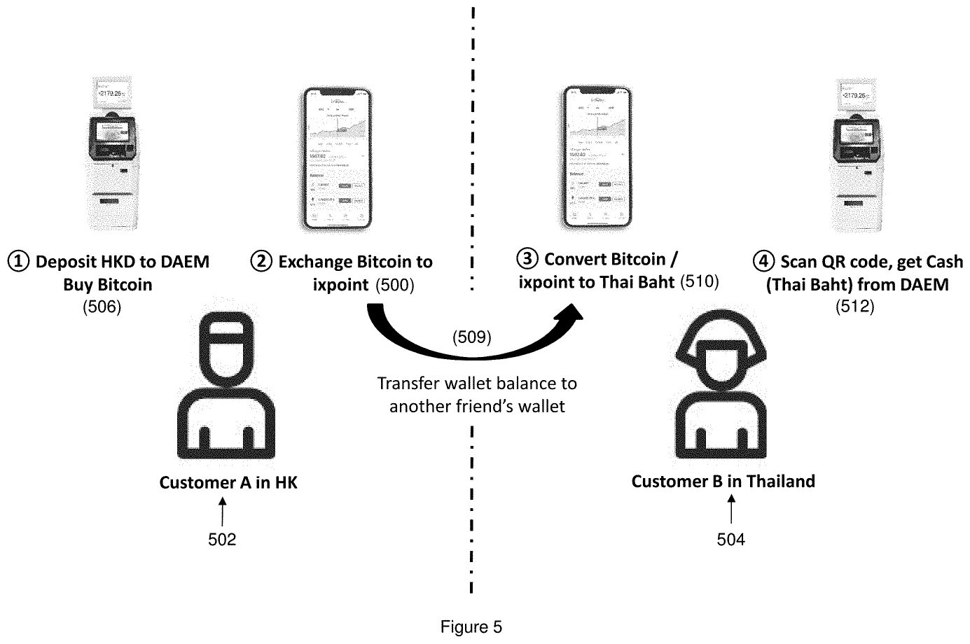

As shown in FIG. 1, both the DAEM 104 and ixWallet 106 is implemented to present at least one index 130 for the user. This information is helpful as it allows the user to track the performance of their digital assets in near real time. This index 130 may be presented as a chart on an interface of the DAEM 104 or within the screen of the ixWallet 106. The updating of the index 130, as well as to its creation is further described below with reference to FIG. 4.

Preferably, this architecture 100 includes an ixPoint system 108 which facilitates the collection, purchase, sale, exchange or transaction of points, also referred to as ixPoints. In this example embodiment, the ixPoints or points may operate as a form of digital currency that could be used like regular currency in exchange for goods, services, or assets as well as being used as a medium of exchange, settlement and remittance with an exchange 102, individual, merchant, bank, government etc. The ixPoints could be structured to be a commonly recognized currency, and in order to increase its ease of use and adoption, it may also be artificially created to have the same value as a local currency (1:1), such as the Hong Kong dollar.

For the IxPoints to be a digital currency that would be recognized and used freely, it may operate to a blockchain system such as the ERC-20 standard and use the same chain system. It may also be necessary for the points to be controlled, at least partially, by a centralised authority such as a monetary authority or central bank. Various structures can provide this central control as required but in one example, the IxPoints system may operate with a layered framework. The first layer being around the use of blockchain technology so as to facilitate the operation of the currency and ledgers which would track the currency's transaction. In turn, this first layer may create the “coin” aspect of the IxPoints system allowing it to be exchanged.

In addition, the bottom technology to build the ixPoint service may include Hyperledger or Corda, and the whole ixPoint system may be equipped with the post quantum computing security technology, even the future quantum computers cannot hack into every single part of the system.

Preferably, ixPoint may be a cryptocurrency issued by the operator of the system, such as ixFintech, and it is a stable coin whose value is strictly pegged 1:1 to the Hong Kong Dollar. ixPoint will provides the advantages of both the Hong Kong Dollar such as creditworthiness and blockchain technology such as real-time transparency. Alternatively, ixPoints may be converted from digital asset at their own country at denomination or multiplication of 1, 10, 100, or 1000 (or other denominator/multiplier), to cater for all world currencies if necessary.

Alternatively the ixPoint may pegged to other local currencies and may be of other conversion rates. For example, it is expected that the rate will be confined within a narrow band, e.g. between HK$0.98 per ixPoint to HK$1.02 per ixPoint (0.99<X<1.01). When there is exceptional demand on ixPoint, it can reach HKD 1.01 and once reach this upper band, IX Fintech Group will use it reserve to short in the market. Vice versa, when there is exceptional supply of ixPoint, IX Fintech will support the ixPoint at HKD 1=ixPoint with a lower band of 0.99. As initially the circulating of each ixPoint is supported by real HKD 1, there shall always be enough cash in the system to buy back and support the ixPoint.

It should be noted that factors such as market fluctuations from the transactions among the ixPoint holders and users may change the exchange rate. For example when they sell or buy a significant number of ixPoint, or blockchain delay issue may also change the rate, e.g. If there If a serious delay of processing the transaction of a large number of ixPoints on blockchain, the number of ixPoint in the market will decrease, which in turn will drive down the peg rate.

As a stable coin being associated with the digital assets, the ixPoints allow the users to transfer ixPoint to other accounts. Moreover, there is no difference of identity in the ixPoint system between a customer and businesses as they are both viewed as ixPoint users. In addition, Users can purchase goods and services from ix or other merchants and businesses using ixPoint in their ixWallet. Other merchants and businesses can also collect payments from the customers using the ixPoint system, and ixPoint may be readily exchanged to other digital assets at our exchange or sell other digital assets to get ixPoint.

Moreover, users can transfer the ixPoint to the accounts in other countries/regions and exchange to the logo currencies so that the cross broader remittance can be achieved, and customers can exchange local currencies and foreign currencies through ixPoint at the DAEM. They only need to buy ixPoints by one currency, then move to another machine and sell the ixPoints to get another currency.

A second layer may complement this first layer by use of a centralised system or by use of a private blockchain with merchants, exchanges, banks, government bodies or central monetary authorities to track each of the “coins” and each associated transactions. This second layer may in turn provide the value backing to the digital currency whilst also reducing the public blocked transaction costs and delay in completing the transaction.

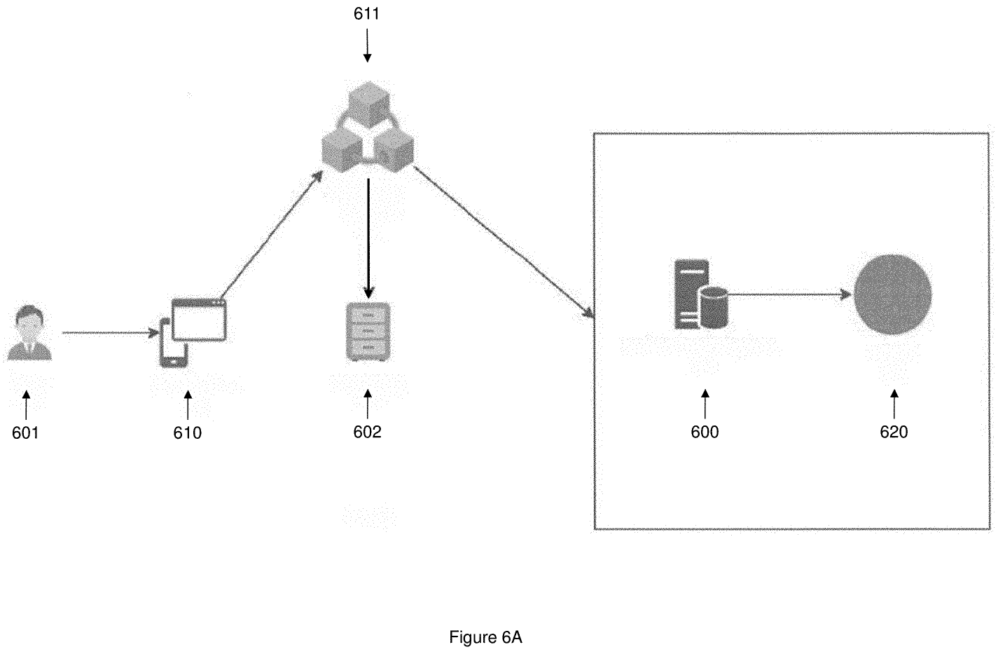

These points may be accumulated, purchased or exchanged by transactions which use the DAEM 104 or ixWallet 106 or any approved transaction systems and thus it may be considered as a form of digital asset or digital currency. These points may then be used as a currency for the purchase of goods or services with utility companies, government departments, banks, professional service providers, individuals or merchants 110, or it may be used, as described below with reference to FIG. 5, as a way in which foreign exchange transactions or remittance overseas may be facilitated.

Preferably, the ixPoint system 108 is implemented such that each (one) point may be exchanged for each (one) unit of local currency (e.g. each Hong Kong dollar for when the system operates in Hong Kong). The maintenance of this constant exchange rate may ease its adoption and usability as a supplemental reward system or currency.

The architecture 100 may therefore operate as a total solution for experiencing and adoption of digital asset by various users. As illustrated, the components operate together to perform the transfer of digital asset, creation of digital asset, destruction of the digital asset as well as the managing of the amount of digital assets, reporting of digital asset holdings, linking digital asset to merchants and to perform payments by regular currency (e.g. cash) as well as points such as IxPoints. In turn, this may also allow the architecture to perform foreign exchange (FX) transactions, whilst ensuring that Know Your Customer (KYC), Anti Money Laundering (AML) requirements are managed. The architecture is also advantageous as it may be able to link financial products on a crypto index, such as ixCrypto Index by providing tokens on financial asset such as index fund tokens.

Additionally, examples of the DAEM 104 and the ixWallet 106 may be used together or separately. The DAEM 104 may let users to insert cash (regular currency) to purchase digital asset as well as to sell digital asset to obtain cash. Examples of the ixWallet 106 may also allow users to perform foreign exchange (FX) and transfer digital asset with other users or merchants, as well as to check digital asset holdings on a distributed ledger. Preferably, the ixWallet 106 may also provide the functionality to allow users to check the Cryptocurrency index 130, such as the ixcrypto index level. This may provide a convenience to users as a transaction to remit funds overseas or to other agents or merchants may be performed within a short amount of time (e.g. 30 mins) rather than 1-2 days with a bank.

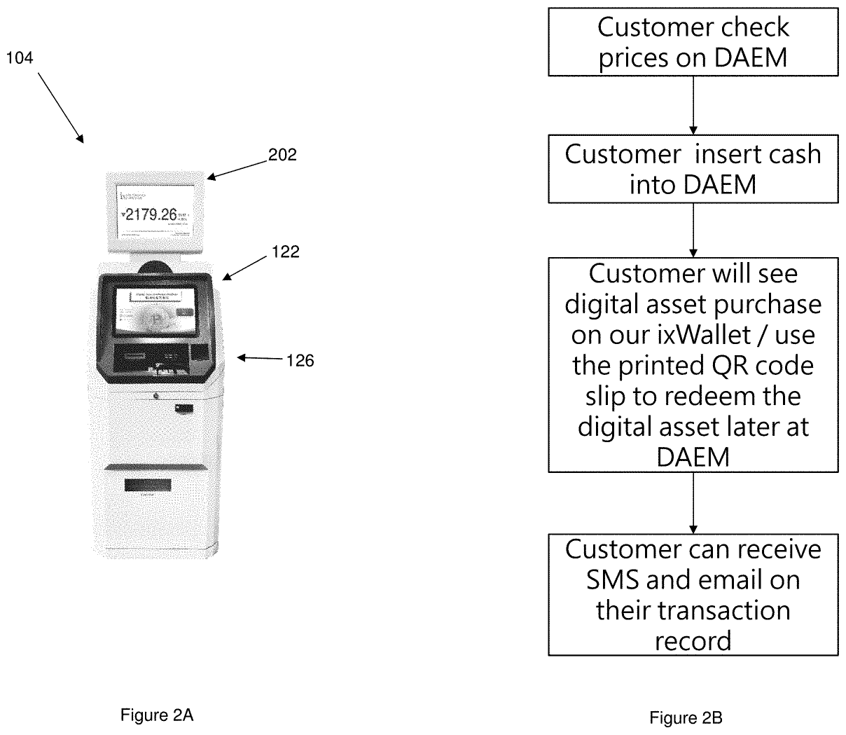

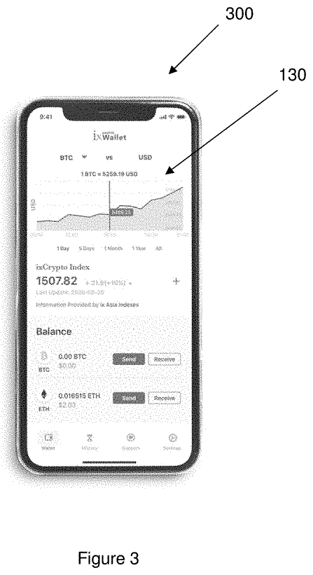

With reference to FIGS. 2A and 2B, there is illustrated an example embodiment of a system for digital asset exchange 104 comprising:
An interface 202 arranged to receive digital asset transaction requests from a user,
A gateway arranged to communicate with one or more exchanges to process the digital asset transaction requests 120. Preferably, the interface 202 is further arranged to present at least one digital asset index 130. This system may also be referred to as a Digital Asset Exchange Machine (DAEM) 104.

As shown, the cryptocurrency index 130, referred to as an ixCrypto Index is shown on the top screen 202 of the machine 104. The index 130 is determined and calculated to reflect the overall performance of the crypto market and provides guidance to the performance of the digital asset.

Preferably, customers may trade not only cryptocurrencies but other kinds of digital assets, including the real asset tokens (asset backed tokens) provided by the tokenization service providers such as ixFintech, stable coins or stable coin tokens.

The DAEM 104 may also support other payment methods and may be equipped with all KYC functions for regulations requirements and thus allowing the DAEM 104 to be used as a transaction point, that use both regular currencies and digital assets for government, utility, private individuals or merchant related services.

Preferably, the DAEM 104 has 3 levels of security protection and thus enhancing their protection from present and future hacking technologies.

In one example of operation of the DAEM 104, the system 104 may be arranged to allow a user to exchange (purchase and sell) digital assets with regular currencies. This operation may follow the following procedures:

Step 1: Customer check prices on DAEM 104, they may check one or more digital asset of interest;

Step 2: Customer inserts cash or provide credit or bank facilities into the DAEM 104;

Step 3: Customer will see digital asset purchase on their digital wallet, such as the ixWallet 106, or the customer may use the printed QR code slip to redeem the digital asset later at our DAEM 104. This printed slip is referred to as a “paper wallet”.

Step 4: Customer may receive SMS and email as their transaction record.

A similar set of procedures also applies to selling digital assets, with the cash being dispensed by the DAEM 104 or transferred to a predetermined account. Accordingly, the DAEM 104, when operating within the architecture for exchanging digital assets, may provide, without limitations, one or more of the following functions:

1. List new cryptocurrencies, tokens and make available for trading.

2. Open digital assets paper wallets account.

3. Exchange cash and cryptocurrencies (buy and sell cryptocurrencies at the machine).

4. Exchange cash and real asset backed tokens (buy and sell tokens at the machine).

5. Exchange cash and security backed tokens (buy and sell tokens at the machine).

6. Exchange cash and other type of digital assets (buy and sell tokens at the machine).

7. Purchase digital coupons and tickets.

8. Purchase of IX Point with IX Point=1 HKD (The IXPoint can therefore operate as an example of a stable coin).

9. Exchange IX point for coupon or cryptocurrencies/tokens or payment with merchants.

10. Remittance to other countries/regions by digital assets (in use together with ixWallet 106 and the DAEM webpage, which is similar to the DAEM, but implemented virtually via a website or app).

11. Currency exchange using digital assets as intermediary service (in use together with ixWallet 106 and the DAEM 104 or DAEM webpage).

12. Viewing of ixCrypto index or other index 130 performance.

13. Advertising screens on the display panel of the DAEM 104.

14. Generate and read QR codes

15. KYC function with finger print, passport and HKID scanning and OCR function.

16. Post quantum computing cryptography—code base cryptography.

17. Provide credit, lending or loan services, whereby a user may provide their identification document and proof of asset holdings or guarantors, followed by the DAEM dispensing regular currencies, cryptocurrencies or Ixpoints.

18. Provide Government services, including the payment of welfare or social security payments, tax payments or refunds, payment of fines or allowances whereby a user may provide their identification document for settlement of Government related payments with regular currencies, cryptocurrencies or Ixpoints.

19. Payments or refunds for merchants or utility companies with regular currencies, cryptocurrencies or Ixpoints.

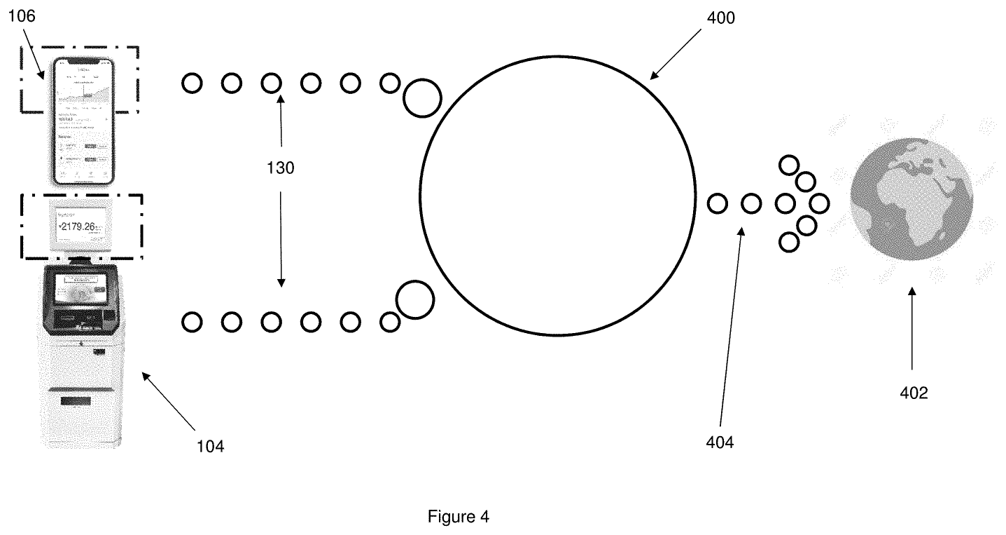

With reference to FIG. 3, there is illustrated an example embodiment of a digital application 300 for digital asset exchange comprising:
a distributed ledger wallet arranged to operate with at least a private key and public key for recording the transaction of digital assets
a gateway arranged to communicate with one or more exchanges to process the digital asset transaction requests; wherein, preferably, the digital application includes an interface for presenting at least one digital asset index 130.

As shown, a digital wallet 106 is arranged to keep track of the transactions of the digital asset and thus allow the owner of the digital asset (the user) to keep track of the digital assets that are in their possession. The digital wallet 106 operates as a distributed ledger, and may include a private and public key (or address) which are shared during transactions such that the user account can be identified and the ledger updated via a distributed process. Preferably, the Application 300 which provides this digital wallet 106 or ixWallet, is an app which operates on a computer device such as a smartphone and is arranged to communicate with a distributed system of the various cryptocurrencies that are tracked with the digital wallet 106. This communication allows the digital wallet 106 to keep track of the ledger and thus the amount of each digital asset the user may hold.

The app 300 is preferably implemented such that it provides the functions of transferring digital assets to other digital wallets. In this example, the digital wallet 106 is not implemented to communicate directly with an exchange so as to permit the exchange of digital assets with other currencies or other digital assets, although such implementations may also be implemented. Instead, the wallet 106 is arranged to be connected to the DAEM 104 shown in FIGS. 2A and 2B to perform the necessary transaction via the exchanges or ixPoint system. It is important to appreciate that a DAEM 104 may also exist and operate as a service on a computing device or cloud service.

As shown, the app 300 also includes an interface which shows one or more cryptocurrency or digital asset indexes 130. In operating with the DAEM 104, the following features may be implemented:

Distributed Ledger Wallet—ixWallet 106 is a distributed ledger wallet, meaning it's decentralized, your digital assets will all be stored on the blockchain but not in the wallet.

Cryptocurrencies (Cryptos) and Tokens—ixWallet 106 enables users to manage not only cryptos but other kinds of digital assets, including the real asset tokens provided by the tokenization service of ixFintech.

ixCrypto Index—The ixCrypto Index is shown together with crypto prices. It is a unique crypto index in Hong Kong, aiming to reflect the overall performance of the crypto market.

Check Balance and Transfer—Customers may, in real time, receive updates on their digital asset account balance, and easily transfer to other users or any other digital wallets.

Safety—ixWallet 106 is also equipped with security features to prevent hacking or false authentications. Technology that may be used include the abovementioned end-to-end email/file encryption and digital signing security.

In this example with reference to FIG. 3B, the application 300, which represents the ixWallet 106, is arranged to permit the user to check their balances and to perform digital asset transfers to other digital wallets. The function of one example digital wallet includes:
IxWallet 106 is a distributed ledger wallet
Registered users can real time receive update on their digital asset account
User can transfer bitcoin, Ethereum to other cryptocurrency wallets. It may also be adapted to perform blockchain remittance.
IxWallet 106 is embedded with post quantum computing tech for security.
A User may check the balance of their digital asset holding.
A User may check the performance of an index 130, such as the ixCrypto index (pending launch of futures and options)

Accordingly, in one example of the digital wallet the following one or more functions, without limitations, may be performed:

1. Exchange IX point for coupon or cryptos/tokens or payment with merchants.

2. Block transaction notification and alert

3. Generate QR code for cash collection and remittance function

4. Currency exchange using digital assets as intermediary service (in use together with DAEM 104 and/or the DAEM 104 virtual service)

With reference to FIG. 4, the DAEM 104 and the digital wallet 106 is arranged to receive the crypto index 130, referred to as ixCrypto. This index 130 is firstly obtained by a clouded based service 400 where the necessary index calculation data (e.g. price of the basket of digital assets) can be obtained from various exchanges or global information vendors 402. This information may then be used to calculate the indexes 130 which will in turn, be sent to both the DAEM 104 and the digital wallets 106 for user access.

As shown, in FIG. 4, the calculation of the index 130 begins by using a cloud based storage service 400 such as AWS storage, which is programmed to perform the following steps:

1) IX Request data from our source 1 (Obtain Different Exchanges data on each constituent cryptocurrencies and pairs per the internal operation rules and guideline or Multiple exchanges on multiple coins on multiple pairs)
2) Source 1 vendor will send signal through API back to IX (One API on source 1 format)
3) IX to obtain data from Source 1
And if Source 1 not available then trigger contingency plan to obtain data from source 2 (Second API on source 2 format)

The calculation of the index 130 may then be performed by the following steps:

Program will calculate the index 130 and disseminate the index 130 regularly, preferably, every 15 seconds, or in any suitable interval in other possible embodiments.

A fee 404 may also be paid to the data source (e.g. Nasdaq Data Fee) as part of the services of obtaining the data.

There are various possible methods to calculating the index 130, but the following example processes and criteria are preferred.

Firstly, eligibility of constituents of the index 130 are considered, preferably, A cryptocurrency is included in the universe if it fulfils both the following eligibility criteria: (a) The cryptocurrency must fit the definition of a cryptocurrency; and (b) The cryptocurrency must be traded publicly, and actively traded on at least two exchanges.

Preferably, a cryptocurrency is eligible for constituent selection if it meets the market capitalization (MC) ranking and the liquidity screening selection as follows.

A Market Capitalization Ranking is considered, in which the cryptocurrency should be among the top n % free float adjusted market capitalization (“adjusted MC”), where n represents the total percentage after including the last eligible cryptocurrency and such percentage should not in any case be lower than 80%.

In a Liquidity screening process, the cryptocurrency should rank in top 25 in terms of 90-day average trading volume, and if the cryptocurrency in top N in terms of adjusted MC cannot meet the liquidity requirement, it will be kicked off and replaced by the next one or more eligible cryptocurrencies until the total coverage exceed 80%.

Cryptocurrencies meeting all of the above eligibility requirements will be considered for inclusion in the ixCrypto Index (IXCI). The final selection may be decided by an operator of the platform, such as IX Asia, after the above criteria have been taken into consideration.

In one preferred embodiment, the number of constituents is a variable. It is subject to change after quarterly review when above conditions are met.

To keep the index neutral and fair, the constituents of the ixCrypto Index may exclude the coins managed/operated by any organizations that would have conflict of interest with the index. These organizations may include crypto exchanges, crypto funds, etc.

Preferably, the digital asset index may be updated according to an index review procedure and/or any changes of the constituents of the digital asset index. For example the digital asset index may be updated based on a weighted average of a report price for each of a plurality of constituent, which may be further associated with an index divisor adjusted based on an update of constituents after a predetermined cut-off date. The index divisor is used to calculate the digital asset index.

For example, the operator of the platform, such as IX Fintech, may undertake regular quarterly reviews of IXCI constituents with data cut-off dates of end of March, June, September and December each year. The review day will be every last weekday of March, June, September and December each year in HKT. A quarterly review may be completed within three weeks after the end of each calendar quarter. In each review, there may or may not be constituent additions or deletions. Eligible candidates will be selected as constituents of the ixCrypto according to rules below.

The first rule may include a “buffer rule”. In order to avoid frequent change of constituents, a 5% buffer zone is set for market capitalization. It means that, in term of adjusted MC, only when the sum of constituents' weights is below 75%, it need reconstitution. Combining the buffer rule and liquidity requirement together, when the coverage falls below 75% or any existing constituent's 90-day average trading volume drop below the top 25. A reconstitution will be conducted to select the new constituents according to principles stated above.

Announcement dates of constituent changes will be the second Friday after the cut-off dates of March, June, September and December.

Effective dates of constituent changes will be the third Friday after the cut-off dates of March, June, September and December.

If the first Friday after the cut-off date is a public holiday, the announcement day and effective day will be postponed for one week, i.e. announcement day on the third Friday and effective day on the fourth Friday.

The second rule may include a “fast entry rule” At any time, a new crypto will be added if it meets below requirements for 5 consecutive days: (a) Daily trading volume ranks top 2; (b) Market capitalization is more than 30% weighting of the total market capitalization; and (c) The fast entry addition will normally be implemented after the close of the 10th trading day.

The third rule may include a “constituents enhancement rule”. After the enhancement, if there are more than one cryptocurrency which shall be included in the new constituents according to market capitalisation ranking and liquidity screening but not being included due to the above captioned rule of no changes, a reconstitution will now be conducted to include the new constituents with bigger market capitalisation and meet the liquidity screening according to principles stated above.

The calculation of the digital asset index or the IXCI is further described as follows.

All constituents may be initially weighted by their adjusted MC. In order to avoid overweighting, the maximum weight for any constituents is 40% (Cap) of the Index's adjusted MC. If a constituent exceeds the Cap, its weight will be reduced to the Cap and the excess weight shall be redistributed across all other constituents.

For example, the initial weights are as below.

| | A | B | C | D | E |
|---|---|---|---|---|---|
| Initial Weight (%) | 50 | 20 | 15 | 14.5 | 0.5 |

With Cap adjustment, each of the weights of the constituents A to E are determined by:

$${w}_{A , adjusted} = min ( {w}_{A , initial} , 40 ) = 40$$

$${w}_{B , adjusted} = {W}_{B , initial} \times \frac{100 - {w}_{A , adjusted}}{100 - {w}_{A , initial}} = 24$$

$${W}_{C , adjusted} = {W}_{C , initial} \times \frac{100 - {w}_{A , adjusted}}{100 - {w}_{A , initial}} = 18$$

$${w}_{D , adjusted} = {w}_{D , initial} \times \frac{100 - {w}_{A , adjusted}}{100 - {w}_{A , initial}} = 17.4$$

$${W}_{E , adjusted} = {w}_{E , initial} \times \frac{100 - {w}_{A , adjusted}}{100 - {w}_{A , initial}} = 0.6$$

So, the adjusted weights are as below.

| | A | B | C | D | E |
|---|---|---|---|---|---|
| Adjusted Weight (%) | 40 | 24 | 18 | 17.4 | 0.6 |

Accordingly, the Index level may be calculated using the following representations:

$${CyptoIndex}_{t} = \frac{{\sum }_{i = 1}^{x} {P}_{i , t} \times {S}_{i} \times {F}_{i}}{{D}_{t}} ,$$

where:
CyptoIndexₜCyptoIndexₜ=the index level on day t
P_{i,t}=the report price for Constituent i on day t, in USD
   Sᵢ=Circulating Supply for Consituent i in current quarter
Fᵢ=Cap factor for Constituent i,
Dₜ=Index Divisor
   x=Number of constituents

In the above representation, the Cap Factor may be calculated as:

$${F}_{i} = \frac{{w}_{i} , adjusted}{{w}_{i} , initial}$$

where:
Fᵢ=Cap factor for Constituent i,
wᵢ,adjusted=Cap adjusted weight for constituent i
wᵢ,initial=Initial weight for constituent i

In addition, the Initial Divisor may be calculated as:

$${D}_{0} = \frac{{\sum }_{i = 1}^{x} {P}_{i , 0} \times {S}_{i} \times {F}_{i}}{Baseline}$$

where:
D₀=Divisor on inception day
P_{i,0}=the report price for Constituent i on inception day, in USD
Sᵢ=Circulating Supply for Consituent i in current quarter
Fᵢ=Cap f actor for Constituent i
Baseline=1000, which is the inception index level
x=Number of constituents

Preferably, the operator of the platform, such as IX Fintech, may undertake regular quarterly index rebalancing with data cut-off dates of end of March, June, September and December each year. The announcement and effective dates are consistent with reconstitution dates as stated above.

As described earlier, the digital asset index is further associated with an index divisor adjusted based on an update of constituents after a predetermined cut-off date. For example, when constituents are changed, re-calculate the divisor using new constituents:

$${D}_{new} = {D}_{old} \times \frac{{\sum }_{i = 1}^{x} {P}_{i , t} \times {S}_{i} \times {F}_{i , new}}{{\sum }_{i = 1}^{n} {P}_{i , t} \times {S}_{i} \times {F}_{i , old}}$$

### Where:

D_{old}=Old Index Divisor in previous month
P_{i,t}=the report price for Constituent i on day t, in USD
Sᵢ=Circulating Supply for Constituent i in current quarter
F_{i,new}=Cap factor for Constituent i in new quarter
F_{i,old}=Cap factor for Constituent i in previous quarter
x=Number of new constituents
n=Number of old constituents

These example index 130 calculation methodologies are advantages as they are calculated to reflect the performance of the cryptocurrency market. This index 130 is designed to be simple to understand while providing a good representation of the crypto market. It aims to cover the top 80% of the cumulative free-floating market capitalization in the crypto universe whilst at the same time falls under the top 25 ranking by trading volume in the 90 days preceding the review date. The index may also be capped at 40% for one single member with the quarterly index review and is by design transparently open and auditable.

With reference to FIG. 5, the point service may further facilitate, between multiple users, payment or transaction of the points having the predetermined value associated with different regular currencies, such as but not limited to, cross-border payment or transaction. For example, users can use the architecture for digital assets exchange 100 to perform foreign exchange and remittance functions. As shown, a user 502 located in a first location, such as Hong Kong, may first buy (506) a cryptocurrency such as bitcoin via the DAEM 104 as described above with reference to FIGS. 2A and 2B with regular currency (Hong Kong Dollar) or other assets. The user 502 may then exchange the Bitcoin (or any other digital asset) into points (508) (or ixpoints) via the ixPoint system 108. The points may then appear on user A's 502 digital wallet 106.

These points may then be transfer by user A 502 via the use of user A's digital wallet 106 to a second user B 504, located in Thailand (509). Upon the successful transfer (509), user B 504 will have the points in their digital wallet 106. User B 504 may then convert the points back into a cryptocurrency or digital asset such as Bitcoin by use of their digital wallet (510), and if preferred, can exchange the digital asset back into their local currency (Thai Baht) via a DAEM 104 located in Thailand (512).

In this example, a foreign exchange transaction is completed without any substantive delays. The conversion of the cryptocurrency into ixPoint (508), as offered by the ixPoint system 108 allows for a simple and predictable transaction from one currency (Hong Kong dollar) to a second currency (Thai Baht) and vice-versa (510). The conversion is simple and predictable as the foreign exchange remittance is not substantially different from the convention method on the fiat FX rate of regular currencies or local currencies. For example, in the example which digital asset value locked for HKD ixPoint needs to exchange for digital asset locked for THB ixPoint, ixPoint calculated in HKD will simply need to be converted or exchanged to ixPoint THB according to the fiat FX rate at the time when the conversion is processed, and then ixPoints can be transferred from user A in Hong Kong to user B in Thailand seamlessly.

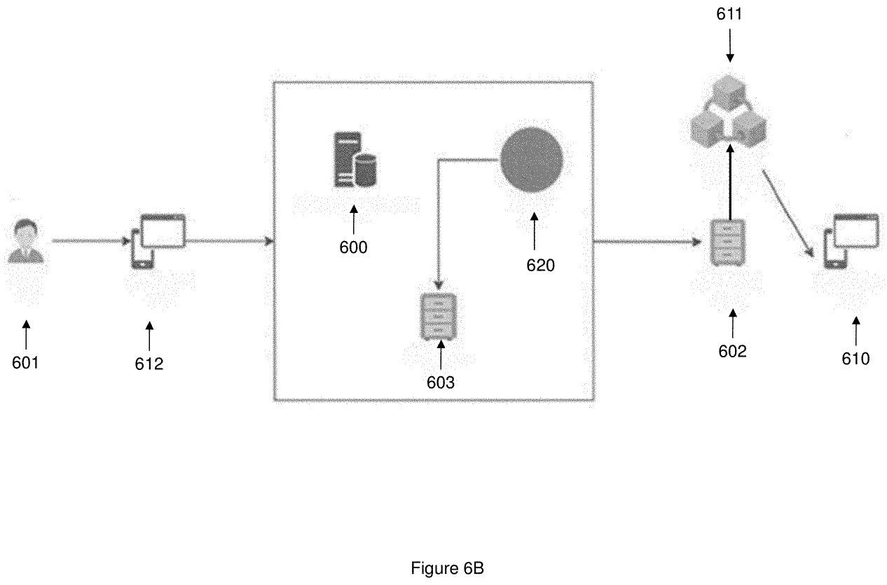

With reference to FIGS. 6A and 6B, there is shown example operations of the digital asset holding in the public domain and the token/points managed in the private domain in accordance with embodiments of the present invention. As described earlier, the digital asset holding may be the actual “cryptocurrencies” owned by the user, with the transactions being recorded on a distributed system such as a blockchain or other decentralized ledger, and in some occasions, updating the records in a distributed system in the public domain may be complex and time consuming. Thus it may be more preferable that transactions related to the cryptocurrencies do not involve an update of the decentralized ledger in the public domain to facilitate “using” the cryptocurrencies similar to making payment with real or regular currencies, and more preferably similar to using local currencies.

In accordance with embodiments of the present invention, there is provided a systems and methods for high frequency and no cost digital asset transactions. The methods and systems discussed herein use a permissioned blockchain or Distributed Ledger Technology (DLT) network. Because the participants in permissioned blockchains are known and trusted by the rest of the network, it is possible to achieve higher speeds and throughput than permissionless chains. Unlike proof-of-work blockchains such as Bitcoin and Ethereum, the system may use a practical Byzantine Fault-Tolerant consensus algorithm to establish transaction finality. There are no mining or transaction costs, and it can execute smart contracts at a much greater scale than open blockchains.

Preferably, upon processing the digital asset transaction requests, the gateway of the DEAM then deposit a digital asset holding owned by the user in a custodian arranged to manage the deposited digital asset holding, and then allocates the matching value of points/token to the user, similar to the ixPoints described earlier. Then, the user may conveniently use ixPoints to make payment in local currencies, and the subsequent consumption/accumulation of ixPoints may only be recorded in the private domain, such as a private server managed by the service provider or operator of the point service system. In this example operation, the point service simply records transactions with points without intervening the deposited digital asset holding managed by the custodian, however as the ixPoints represent a matching value of the actual digital asset holding owned by the user deposited in the custodian, by observing the balance of the ixPoints available, the balance of the digital asset holdings, in local or other regular currencies, in the ixWallet of the user is also known.

Preferably, to realize the multiple identities and functionalities of ixPoint, it will use a combination of a decentralized private chain and a centralized system, in which the inventors also refer such system as the IOU (“I Owe U”) system. For example, the operator, such as ixFintech, may build a private blockchain to mint and burn the ixPoint, as well as the final record of all the transactions of the ixPoint. Blockchain system are transparent and immutable, thus the ixPoint will have these advantages same as other cryptocurrencies.

The transactions of the ixPoint will temporally use the IOU method at the first stage. As the transactions on public blockchain usually require more time to proceed (for example, minutes on the ERC20 chain, and even hours on the Bitcoin chain), the transactions will be first recorded by the IOU, making the transactions instantly complete like other payment methods, such as the payment system that may be used in physical point of sales (POS).

The operator may also set a settlement time every day to settle all the transactions within the day, record all the IOU transactions to the blockchain system, making these records permanent and immutable.

The architecture for exchanging digital assets may be utilized as a complete ecosystem in which all products and services can be purchased by the ixPoint, and people can currency exchange and remittance easily through the ixPoint, which is backed or associated with the digital assets managed by the custodian.

For example, in the previous embodiment of FIG. 5 where cross-border payment or transaction may be completed using the architecture for digital assets exchange 100, upon receiving a request from user A 502 in Hong Kong to transfer certain amount of ixPoint (508) in the user A's digital wallet 106 to the second user B 504 in Thailand, the system only record the change of balance of the ixPoint (508) in the digital wallets of both users upon completing the cross-broader transaction, without intervening the actual amount of digital asset holding deposited in the custodian, therefore delays due to updating the blockchain associated with the cryptocurrency may be eliminated.

Subsequently, user B 504 may choose how to use/convert the points in their digital wallet 106, e.g. may simply keep the ixPoint balance which has a market value mirroring the ixCrypto index, in this case, the deposited digital asset holding managed by the custodian is kept unchanged. Alternatively, the user B may exchange the digital asset back into their local currency (Thai Baht) via a DAEM 104 located in Thailand (512), then the system will proceed to burn the ixPoint upon withdrawal of Thai Baht or other currencies of the same market value, the burn request will be explained later in this disclosure.

If user A or user B decide to sell the cryptocurrencies and if the new owner of the digital asset holding is not a user of the ixPoint/ixWallet system, the transaction of the digital asset holding/cryptocurrency will be completed by updating the actual blockchain, then an amount of deposited digital asset holding that matches with the value of the ixPoint being sold will be released from the custodian in the public domain, after completing a burn request similar to the local currency withdrawal example.

Preferably, the point exchange module is further arrange to facilitate digital payment at a physical point of sales associated with the points, for example, by utilizing one or more digital payment instrument which may be deployed or used in various physical point of sales, such as brokerage and banks in the finance sector, street vendors, restaurants and vending machine in the food and restaurant sector, stores, malls or supermarkets in the retail sector, and even for payment in the tourism and hospitality or any possible services.

To facilitate digital payment, digital payment instruments such as terminals or kiosks may be installed, to scan or receive a payment request from a user. For example, users may scan the QR codes of the merchants or show their QR codes to the merchants to finish the payment in purchasing goods and services. Alternatively or optionally, hardware such as RFID/NFC readers and suitable software may be used to read payment information from payment cards or smartphone applications similar to other contactless payment systems.

It should be appreciated by a skilled person in the art that, transactions conducted via the system can be any type of digital assets, including the transfer of crypto or digital currency (e.g. Bitcoin, virtual amounts of fiat currencies, tokenized assets on any blockchains etc.) In other words, the methods and systems discussed herein may be applicable to transactions of any type of digital assets. While the system may be described with respect to a transfer of digital currency, the techniques discussed herein are thus applicable to transactions of any type of digital assets.

Referring to FIG. 6A, to use the system 600, a user 601 may transfer his digital asset holdings natively living on other blockchains 611 to the system operator's custodian 602 through the user device 610 (e.g. a crypto wallet) or using the DEAM, an entity that holds an equivalent amount of the asset as the tokenized copies (tokens) inside the system (e.g. a multisig wallet, DAO or vault smart contract). Same amount of tokens 620 that are pegged to the value of the original digital assets will be minted on the system which is in the private domain. The system may keep monitoring the transactions in blockchain network 611, once the transaction is confirmed with enough confirmations (e.g. proofs) on blockchain, the tokens 620 minted on our system will be unlocked and able to use inside the point service system, which is independent from the blockchains or the distributed ledger.

When the tokens 120 need to be exchanged back to the original digital asset, referring to FIG. 6B, the user 601 may send a burn request of tokens 620 to the custodian 603, a smart contract inside system 600 may be generated using his device 612 (a mobile app or web-base system that can call to API of system 600). After the burn request is committed, the digital asset holding may then be released from the reserve custodian 602 to user device 610 (the address prefer by the user to receive the digital assets holdings) through the public blockchain network.

In this example, the user owning tokens that represent their digital assets may transfer its ownership freely anytime to another user on the system by sending a transaction request to the system. The transactions may be done on the system which may use a practical Byzantine Fault-Tolerant consensus algorithm to establish transaction finality.

Preferably, the system 600 may use a practical Byzantine Fault-Tolerant (PBFT) consensus algorithm to establish transaction finality. In particular, PBFT is a voting-based consensus algorithm that is:
Byzantine fault tolerant: As long as a minimum percentage of nodes are connected, working properly, and behaving honestly, network liveness and safety are guaranteed even when some nodes are faulty or malicious
Non-forking: Different from lottery-style consensus algorithms such as Proof of Work (PoW) or Proof of Elapsed Time (PoET), blocks committed by nodes are final,
Leader-based: A primary node (Leader) is elected and responsible for producing candidate blocks, secondary nodes (Follower) vote on the blocks produced by the primary node. Change of leader is in a round-robin (circular) order.
Communication-intensive: Nodes send many messages to reach consensus, commit blocks, and maintain a healthy leader node.

Advantageously, the method and system discussed herein may increase interoperability between different blockchains and the underlying tokens can, in essence, go cross-chain through conversion of digital assets into tokenized version that are supported in different blockchain, since many blockchain have their own token standards, (e.g. ERC-20 for Ethereum, NEP-5 for NEO).

In addition, the system may effectively reduce transaction times and fees, since public blockchain like Bitcoin is slow and expensive to use. By creating tokenized copies, such as fiat coins or mirror coins, of digital asset holdings in the private domain of the system, non-native tokens are able to be transferred at faster transaction times in the same place without fee.

Moreover, as ixPoint and other digital assets are both built on the blockchain network, it is more convenient for investors to purchase digital asset via ixPoint. The value of ixPoint is embedded on the case that it acts as the medium which facilitates investors to buy digital asset. Advantageously, investors may buy/sell digital assets simply by purchasing or selling ixPoints or the fiat coins.

The embodiments of the present invention also transforms the traditional financial environment into a Fintech ecosystem, as the ixPoint service has many advantages from traditional fiat currency and blockchain technology, and the ixPoint mirror coin solution also solves multiple issues related to finance in life such as daily small-amount transactions, digital asset and securities.

These embodiments may also be advantageous in that, it provides a fiat coin system based on local currency mirroring the decentralized blockchain-based coin or cryptocurrency. The ixPoint system facilitates payment/transaction using cryptocurrencies that are linked to a digital wallet owned by a user, in which the ixPoints are allocated in digital wallet of the user upon a deposit of cryptocurrency of certain value in the exchange platform, and the ixPoints represent the real-time market value, in local currencies, of the deposited cryptocurrency managed by a custodian separated from the IX point platform.

As the subsequent transactions involved in the digital wallet only process the ixPoints being allocated but not the deposited cryptocurrency managed by the custodian, therefore the transaction will be much simpler and faster than processing the actual cryptocurrency, as it does not involve updating the blockchain associated with the cryptocurrency until the deposited cryptocurrency is further traded, withdrawn or transferred by the user. The ixPoints are centralized fiat coin stored in a digital wallet and managed by the IX points system, which mirror the decentralized blockchain-based coin of cryptocurrency.

In addition, the embodiments of the present invention also provide a unique clearance methodology for absorbing price movement of the cryptocurrency and facilitating trading using the cryptocurrency. In particular, the ixPoint system synchronize the IX points in the digital wallet according to the market value the cryptocurrency in a real-time manner, or at least periodically, so that the ixPoints mirror the true market value of the deposited cryptocurrency managed by the custodian, such that the user may use the mirrored cryptocurrency flexibly similar to other digital wallets based on deposits of local or other currencies.

Last but not least, special electronic system and apparatus in some preferred embodiments may be included for completing transaction using the cryptocurrency in physical point of sales. With such system architecture, dedicated kiosks such as the DEAM and mobile payment instruments such as a RFID/NFC cards and/or applications being installed in mobile devices may be implemented to facilitate cryptocurrency-based transaction via mirror coins or the ixPoints allocated to the user's account.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A system for digital asset exchange comprising:
an interface arranged to receive digital asset transaction requests from a user; and
a gateway arranged to communicate with one or more exchanges to process the digital asset transaction requests.

2. A system for digital asset exchange in accordance with claim 1, wherein the digital asset transaction request includes an exchange of digital assets with regular currencies.

3. A system for digital asset exchange in accordance with claim 1, wherein the interface is further arranged to receive at least one digital asset index.

4. A system for digital asset exchange in accordance with claim 1, further including a point service arranged to perform transactions with points.

5. A system for digital asset exchange in accordance with claim 4, wherein the points have a predetermined value associated with a selected regular currency.

6. A system for digital asset exchange in accordance with claim 5, wherein the point service exchanges points for digital assets or regular currencies.

7. A system for digital asset exchange in accordance with claim 5, wherein the point service is further arranged to facilitate, between multiple users, payment or transaction of the points having the predetermined value associated with different regular currencies.

8. A system for digital asset exchange in accordance with claim 7, wherein the point service is further arranged to facilitate cross-border payment or transaction.

9. A system for digital asset exchange in accordance with claim 1, wherein the digital asset exchange is arranged to receive regular currencies.

10. A system for digital asset exchange in accordance with claim 1, wherein a digital wallet is generated for a user upon a digital asset exchange transaction if performed.

11. A system for digital asset exchange in accordance with claim 10, wherein digital wallet includes a wallet identification code.

12. A system for digital asset exchange in accordance with claim 11, wherein the wallet identification code is presented in paper form.

13. A system for digital asset exchange in accordance with claim 1, wherein the system further includes an authentication module arranged to authenticate the user.

14. A system for digital asset exchange in accordance with claim 13, wherein the authentication module is further arranged to verify the user based on at least one of biometric information authentication and identity document authentication.

15. A system for digital asset exchange in accordance with claim 14, wherein the authentication module comprises at least one of a face-recognition camera, a fingerprint scanner, and an optical imager arranged to scan an identity document of the user.

16. A system for digital asset exchange in accordance with claim 5, wherein the system is further arranged to interact with a user digital wallet service to facilitate the transaction of the digital asset transaction requests.

17. A system for digital asset exchange in accordance with claim 16, wherein the user digital wallet service is compliance checked before the digital asset transaction requests are processed.

18. A system for digital asset exchange in accordance with claim 17, wherein the compliance check includes a review of the history of past transactions of the digital wallet service.

19. A system for digital asset exchange in accordance with claim 18, wherein the user digital wallet service is a distributed ledger wallet.

20. A system for digital asset exchange in accordance with claim 16, wherein the gateway further arranged to, upon processing the digital asset transaction requests, deposit a digital asset holding owned by the user in a custodian arranged to manage the deposited digital asset holding.

21. A system for digital asset exchange in accordance with claim 20, wherein the deposited digital asset holding has a market value associated with the predetermined value of the points allocated to the user upon processing the digital asset transaction requests.

22. A system for digital asset exchange in accordance with claim 21, wherein the point service is arranged to perform transactions with points without intervening the deposited digital asset holding managed by the custodian.

23. A system for digital asset exchange in accordance with claim 3, wherein the digital asset index is updated approximately every 15 seconds.

24. A system for digital asset exchange in accordance with claim 3, wherein the digital asset index is updated based on a weighted average of a report price for each of a plurality of constituent.

25. A system for digital asset exchange in accordance with claim 24, wherein the digital asset index is further associated with an index divisor adjusted based on an update of constituents after a predetermined cut-off date.

26. A digital application for digital asset exchange comprising:
a distributed ledger wallet including at least a private key and public key for recording the transaction of digital assets; and
a gateway to communicate with one or more exchanges to process the digital asset transaction requests.

27. A digital application in accordance with claim 26, wherein the digital applications includes an interface arranged to present at least one digital asset index.

28. A digital application in accordance with claim 26, wherein the digital application is arranged to operate with a system for digital asset exchange in accordance with claim 1.

29. An architecture for exchanging digital assets comprising:
at least one system for digital asset exchange in accordance with claim 1;
a point exchange module arranged to perform the exchange of points with digital assets or regular currencies;
at least one exchange arranged to perform digital asset transactions; and
a digital application comprising:
a distributed ledger wallet including at least a private key and public key for recording the transaction of digital assets; and
a gateway to communicate with one or more exchanges to process the digital asset transaction requests.

30. An architecture for exchanging digital assets in accordance with claim 29, wherein the point exchange module is further arranged to facilitate digital payment at a physical point of sales associated with the points.

31. An architecture for exchanging digital assets in accordance with claim 30, wherein the point exchange module includes a digital payment instrument.
